(19) United States
(12) Patent Application Publication
(10) Pub. No.: US 2026/0347214 A1
(43) Pub. Date: Nov. 5, 2026

(54) WATER PITCHER WITH FILTER

(71) Applicant: Filter Group USA Inc., Houston, TX (US)

(72) Inventors: Benjamin Seidman, Houston, TX (US); Sungyoun Oh, North York (CA); Justin Malone, Houston, TX (US); Michael Gingras, Sainte-Marie (CA); Andre Lehoux, Sainte-Marie (CA); Miguel A. Castellote, Frampton (CA)

(21) Appl. No.: 19/660,819

(22) Filed: Apr. 28, 2026

Related U.S. Application Data
(60) Provisional application No. 63/797,630, filed on Apr. 30, 2025.

(51) Int. Cl. C02F 1/00; B01D 27/08

(52) U.S. Cl. CPC C02F 1/003; B01D 27/08; B01D 2201/0423; B01D 2201/29; B01D 2201/301; C02F 2201/006

(57) ABSTRACT

A water pitcher includes a container body having a spout and a handle, a filter basket which rests within and is suspended by the container body, a lid which covers and closes the filter basket, and includes at least one locking tab on a front portion of the lid and an opening tab on a rear portion of the lid, which covers an upper portion of the handle. The container body and filter basket each define a locking opening, and the lid covers the filter basket such that the locking tab engages the locking opening.

### CROSS-REFERENCE TO RELATED APPLICATIONS

The present application claims priority to, and the benefit of, United States Provisional Patent Application No. 63/797630, filed on Apr. 30, 2025, the entire contents of which are incorporated herein by reference.

### FIELD

The present invention relates to a water pitcher with a filter cartridge.

### BACKGROUND

Drinking water, such as water from water purification facilities or municipal water, can contain certain additives or contaminants (referred to herein collectively as contaminants) such as chlorine, chloramines, or various organic components. Chlorine is typically intentionally added to water to control microbes. For some, chlorinated water imparts an unpleasant taste or smell. Its presence may also raise health concerns to some consumers.

Existing pour-through pitcher systems allow a user to fill a reservoir of the pitcher with water, which passes (under influence of gravity) through a filter, which removes contaminants from the water. The filtered water exits the filter into the main body of the pitcher, providing filtered water for drinking.

One disadvantage of existing systems is that it may take several minutes for water introduced into the reservoir of such a system to be filtered, and ready for drinking. It would be beneficial to provide systems that might provide filtered water poured from a pitcher or other container where the time required to filter may be reduced.

Also, it may be inconvenient for a user to fill the pitcher or to replace the filter, as a pitcher lid may be inconvenient to remove or replace.

### SUMMARY

In one aspect, disclosed is a water pitcher comprising:
(a) a container body defining an internal volume and a spout; and comprising a handle;
(b) a filter basket configured to rest within and suspended by the container body, the filter basket closing the container body except for the spout;
(c) a lid configured to cover and close the filter basket, comprising at least one locking tab on a front portion of the lid, and an opening tab on a rear portion of the lid;
wherein one or both of the container body and filter basket defines a locking opening, and wherein, upon assembly, the lid covers the filter basket such that the locking tab engages the locking opening, preventing disengagement of the lid when the lid is in place, and the opening tab covers an upper portion of the handle.

In some embodiments, the water pitcher may comprise one or more of the following features:
(a) the lid comprises a refill lid covering a refill opening defined by the lid, wherein the refill lid comprises a refill tab, disposed proximate the upper portion of the handle so as to be operable by a user digit when grasping the handle;
(b) the container body and filter basket having a non-cylindrical shape, preferably a substantially rectangular cross-section;
(b) a filter cartridge which inserts into the filter basket and which has a non-circular cross-section, preferably a quadrilateral shape, more preferably a square shape; and/or
(c) the filter basket has a large capacity, preferably more than 25%, 30% or 35% of the total capacity of the container body.

### BRIEF DESCRIPTION OF THE DRAWINGS

In the drawings, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

FIG. 1 shows a pictorial view of one embodiment of a water pitcher described herein.

FIG. 2A shows an unassembled view of some elements of the water pitcher shown in FIG. 1.

FIG. 2B shows a lid portion of the water pitcher.

FIG. 3 shows a cross-sectional view of the water pitcher shown in FIG. 1.

### DETAILED DESCRIPTION

The invention relates to a water pitcher having a pour through filter assembly. Any term or expression not expressly defined herein shall have its commonly accepted definition understood by a person skilled in the art.

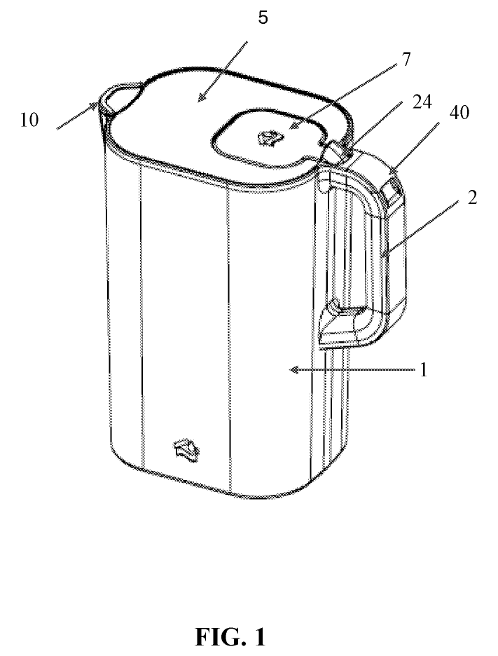

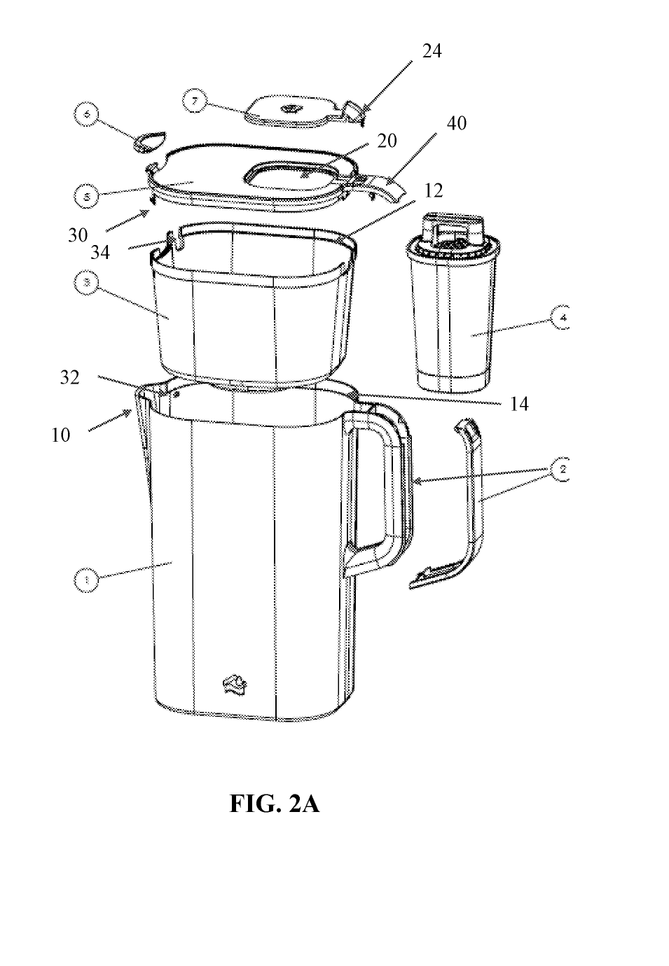

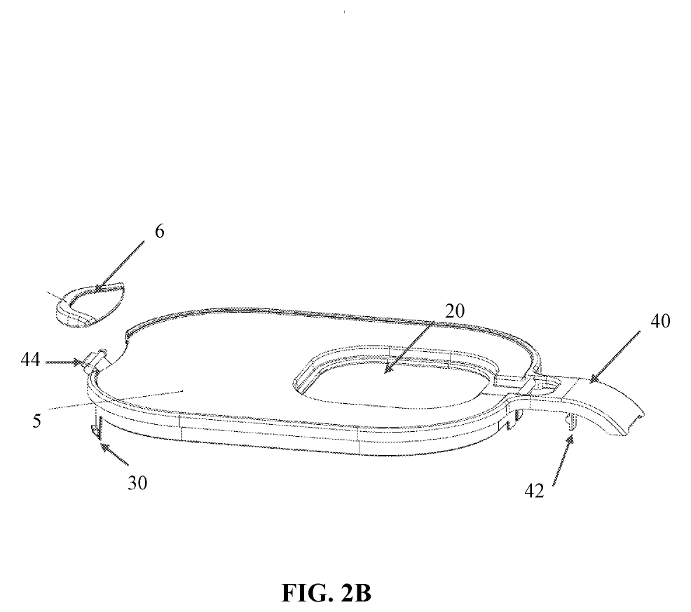

FIGS. 1-3 show an exemplary water pitcher, comprising a container body 1, a filter basket 3 and a lid 5. The container body 1 comprises a spout 10 and a handle 2. The lid is friction fit into the top of the filter basket 3, which include a circumferential shoulder 12 which fits into and rests on a corresponding ledge 14 formed in the top of the container body. The filter basket 3 and container body 1 are sized so as to closely fit together, while allowing for easy manual disassembly. A lid 5 preferably includes a spout cover 6 which is configured to pivot open when water is poured out of the spout 10.

As used herein, the “front” of the pitcher is the side with the spout 10, while the “rear” of the pitcher is the handle 2 side.

Preferably, all elements of the water pitcher are fashioned from molded plastic or are 3D printed, which permits small details or features designed to facilitate the closely matched assembly of the different pieces.

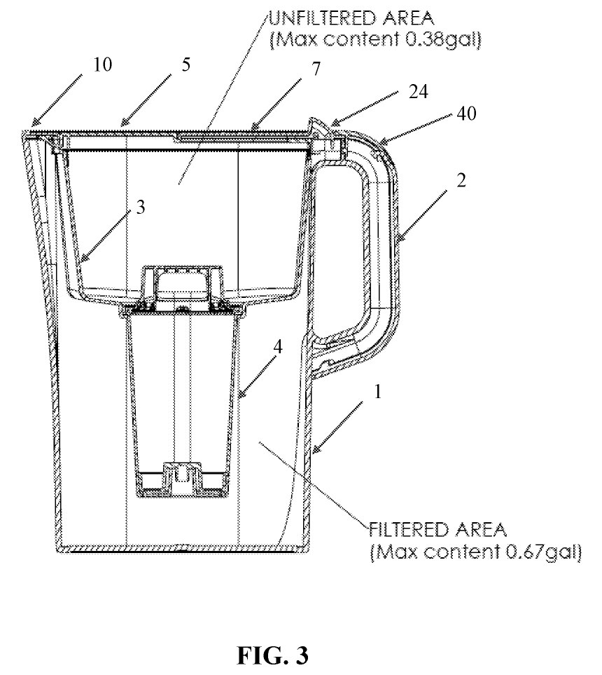

A filter cartridge 4 is configured to fit in a water-tight manner into the filter basket 3 and protrude into the filtered water volume, as shown in FIG. 3. The top of the filter cartridge defines inlet openings while a lower portion of the filter cartridge defines outlet openings. Thus, water in the filter basket 3 will pour through the inlet openings, through the filter element in the filter cartridge 4 and out the outlet openings, into the filtered volume defined between the container body 1 and the filter basket 3. In some embodiments, the filter cartridge 4 has a substantially square cross-sectional shape, with rounded corners, which can provide greater internal volume than a similar circular or oval shape.

The lid 5 defines a refill opening 20 and a refill lid 7. The refill lid 22 is pivotally mounted to the lid 5 and includes a thumb-actuated raised flip tab 24 as means for opening the refill lid.

The lid includes at least one locking tab 30 which comprises a portion which fits within a lock opening 32 defined by the container body and/or the filter basket. If the lock opening is defined by the container body, the filter basket 3 may form a notch 34 to accommodate the locking tab 30. When assembled and closed, the lid locking tab cooperates with the lock opening to prevent vertical motion of the lid 5 relative to the container body 1, while permitting horizontal motion. A rear portion of the lid includes an opening tab 40 which covers an upper portion the handle. A small catch 42 engages an internal portion of the handle 10 to retain the lid in position when installed. The opening tab 40 defines a notch which creates a gap between the opening tab 40 and the handle 2, which permits a user to insert a thumb or finger to disengage catch 42, pivot the rear portion of the lid upwards. A fulcrum 44 levers against the spout when the rear of the lid is pushed upwards, which disengages the locking tab 30 from the lock opening 32. The user may then remove the lid 5 by pulling the lid away to disengage the locking tab 30.

Thus, both the refill lid 7 and the main lid 5 may be opened by a user using their thumb while grasping the handle. The user’s thumb will be positioned near the gap between the opening tab 40 and the handle 2, and also proximate the flip tab 24. At the same time, the locking tab 30 and catch 42 prevent unintended opening of the lid 5, such as when the pitcher is tilted to pour water out of the pitcher.

In one embodiment, the container body 1 has a non-cylindrical shape, which is preferably has a substantially quadrilateral cross-sectional shape. A substantially quadrilateral shape has four opposing sides, such as a rectangle, but the corners may be rounded, as may be seen in FIG. 1.

In one embodiment, the filter basket volume is the unfiltered volume of the pitcher, and preferably comprises a substantial proportion of the total pitcher volume. For example, as shown in FIG. 3, the total pitcher volume may be about 1.05 gallons (4.0 litres) and the unfiltered volume may be greater than about 25%, 30% or 35% of the total volume. In the specific example illustrated, the unfiltered volume is about 36% of the total volume. The volume of the filter cartridge itself is not included in the unfiltered volume as it is suspended within the filtered volume of the pitcher.

### Interpretation

The corresponding structures, materials, acts, and equivalents of all means or steps plus function elements in the claims appended to this specification are intended to include any structure, material, or act for performing the function in combination with other claimed elements as specifically claimed.

References in the specification to "one embodiment", "an embodiment", etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as "solely," "only," and the like, in connection with the recitation of claim elements or use of a "negative" limitation. The terms "preferably," "preferred," "prefer," "optionally," "may," and similar terms are used to indicate that an item, condition or step being referred to is an optional (not required) feature of the invention.

The singular forms "a," "an," and "the" include the plural reference unless the context clearly dictates otherwise. The term "and/or" means any one of the items, any combination of the items, or all of the items with which this term is associated. The phrase "one or more" is readily understood by one of skill in the art, particularly when read in context of its usage.

The term "about" can refer to a variation of ± 5%, ± 10%, ± 20%, or ± 25% of the value specified. For example, "about 50" percent can in some embodiments carry a variation from 45 to 55 percent. For integer ranges, the term "about" can include one or two integers greater than and/or less than a recited integer at each end of the range. Unless indicated otherwise herein, the term "about" is intended to include values and ranges proximate to the recited range that are equivalent in terms of the functionality of the composition, or the embodiment.

As will also be understood by one skilled in the art, all language such as "up to", "at least", "greater than", "less than", "more than", "or more", and the like, include the number recited and such terms refer to ranges that can be subsequently broken down into sub-ranges as discussed above. In the same manner, all ratios recited herein also include all sub-ratios falling within the broader ratio.

The claimed invention is:

1. A water pitcher comprising:
(a) a container body defining an internal volume and a spout; and comprising a handle;
(b) a filter basket configured to rest within and suspended by the container body, the filter basket closing the container body except for the spout;
(c) a lid configured to cover and close the filter basket, comprising at least one locking tab on a front portion of the lid, and an opening tab on a rear portion of the lid;
wherein one or both of the container body and filter basket defines a locking opening, and wherein, upon assembly, the lid covers the filter basket such that the locking tab engages the locking opening, preventing disengagement of the lid when the lid is in place, and the opening tab covers an upper portion of the handle.

2. The water pitcher of claim 1, wherein the lid comprises a refill lid covering a refill opening defined by the lid, wherein the refill lid comprises a refill tab, disposed proximate the upper portion of the handle so as to be operable by a user digit when grasping the handle.

3. The water pitcher of claim 1, wherein the container body and filter basket having a non-cylindrical shape.

4. The water pitcher of claim 3 wherein the container body and filter basket have a substantially rectangular cross-section with rounded corners.

5. The water pitcher of claim 1, further comprising a filter cartridge which inserts into the filter basket and which has a non-circular cross-sectional shape.

6. The water pitcher of claim 5 wherein the filter cartridge has a quadrilateral cross-sectional shape.

7. The water pitcher of claim 6 wherein the filter cartridge has a square cross-sectional shape.

8. The water pitcher of claim 1, wherein the filter basket has a volume of more than 25% of the total volume of the container body.

9. The water pitcher of claim 8 wherein the filter basket has a volume of more than 30% of the total volume of the container body.

10. The water pitcher of claim 9, wherein the filter basket has a volume of more than 35% of the total volume of the container body.
